(19) United States
(12) Patent Application Publication
(10) Pub. No.: US 2012/0063018 A1
(43) Pub. Date: Mar. 15, 2012

(54) LENS ACTUATOR

(76) Inventors: Hideki SHIGEMOTO, Okayama (JP); Norifumi Sata, Hyogo (JP)

(21) Appl. No.: 13/227,551

(22) Filed: Sep. 8, 2011

(30) Foreign Application Priority Data
Sep. 10, 2010 (JP) 2010-202588

(51) Int. Cl. G02B 7/04

(52) U.S. Cl. 359/824

(57) ABSTRACT

A lens actuator includes a box-shaped housing, a prism-shaped carrier, magnets, and coils. The housing accommodates the carrier to be movable along a first direction therein, and the carrier includes a hollow space where a lens can be mounted. The magnets are disposed at one of the carrier or the housing. The coils are disposed at one of the housing or the carrier such that the coils confront the magnets. When the magnets are disposed at the carrier, the coils are disposed at the housing, and when the magnets are disposed at the housing, the coils are disposed at the carrier. The carrier includes first flat guide section formed on a corner of the outer wall, and the housing includes second flat guide section formed on a corner of the inner wall, and the first guide section confront to and slide along the second guide section.

### FIELD OF THE INVENTION

The present invention relates to a lens actuator to be used in a portable phone, an electron camera, and the like.

### BACKGROUND OF THE INVENTION

In recent years, portable phones and electron cameras equipped with a lens actuator that performs auto-focusing for the lens have gained popularity in the market, which thus requires an inexpensive and reliable lens actuator.

A conventional lens actuator is described with reference to FIGS. 4 and 5. FIG. 4 is a sectional view of the conventional lens actuator, and FIG. 5 is an exploded perspective view of the conventional lens actuator. This lens actuator is formed of carrier 1, magnets 2, housing 3, coil 4, cover 5, and shafts 6. Carrier 1 is shaped like a prism and made of insulating resin. Carrier 1 includes cylindrical hollow space 1A at the center.

Magnets 2 are shaped like plates and rigidly mounted on the outer wall of carrier 1 at the four lateral faces. Housing 3 is shaped like a box and made of insulating resin. Housing 3 includes hole 3A on the bottom at the center. Coil 4 is wound in an approx. rectangular shape on the outer wall of housing 3 and made of copper alloy.

Housing 3 accommodates carrier 1 such that each magnet 2 confronts coil 4. Cover 5 is made of metal and covers a top face of housing 3. Cover 5 includes round-shaped through-hole 5A. Shaft 6 is a cylindrical rod. Each one of multiple shafts 6 is inserted into each one of multiple though-holes 1B, and both ends of each shaft 6 are held by housing 3, so that carrier 1 can be guided by shafts 6 and can move vertically in housing 3.

A lens (not shown) is mounted in hollow space 1A of the lens actuator discussed above, and an image sensor is placed behind (lower side in FIG. 4) the lens actuator, which is then mounted in an electronic device, e.g. portable phone or electron camera. Coil 4 is connected to an electronic circuit (not shown) of this electronic device via multiple electrodes or lead-wires (not shown).

When a user presses a predetermined button (not shown) of the electronic device, the electronic circuit applies a voltage to coil 4 and an electric current runs through coil 4 in a predetermined direction, and vertical force perpendicular to and in response to the running direction of the electric current works on magnets 2. Magnets 2 and carrier 1, to which magnets 2 are mounted, are moved, e.g. downward in housing 3 with the aid of shafts 6 that guide carrier 1. As a result, a focus of the lens mounted in hollow space 1A of carrier 1 is set at a standard mode which allows the camera to shoot an image whichever a distant one or a close one.

When the user presses another button (not shown), an electric current reversal to the foregoing one runs through coil 4, so that magnets 2 receive upward force, i.e. reversal to the foregoing downward force. Carrier 1 is thus moved upward in housing 3 with the guide by shafts 6. As a result, the focus of the lens mounted in hollow space 1A is set at a close-up mode which allows the camera to shoot an object as close as within a range from several cm (centimeter) to several tens cm.

To be more specific, when an electric current running in a given direction is applied from the electronic circuit of the device to magnets 2, carrier 1 to which magnets 2 are mounted moves downward or upward in housing 3 with an aid of shafts 6 that guide carrier 1. As a result, the focus of the lens mounted in hollow space 1A can be set at the standard mode or the close-up mode.

The foregoing conventional art is disclosed in, e.g. Unexamined Japanese Patent Application Publication No. 2010-19962.

The conventional lens actuator discussed above includes carrier 1 that is held in housing 3 by multiple shafts 6, which guide carrier 1 to move downward or upward in housing 3. This structure thus needs a number of components and is obliged to be complicated, which takes a lot of time to assemble this lens actuator.

### SUMMARY OF THE INVENTION

The present invention provides a reliable lens actuator with a simple structure. The lens actuator of the present invention has a box-shaped housing, a prism-shaped carrier, magnets, and coils. The carrier is accommodated in the housing and movable in the housing along a first direction. The carrier includes a hollow space in which a lens can be mounted. The magnets are mounted to either one of the carrier or the housing. The coils are disposed at either one of the housing or the carrier such that the coils confront the magnets. In a case where the magnets are mounted to the carrier, the coils are disposed at the housing. In a case where the coils are mounted to the carrier, the magnets are disposed at the housing. The carrier has first flat guide section on a corner of the outer wall. The housing has second flat guide sections on a corner of the inner wall, and the second guide section confronts to the first guide section such that the second guide section can slide along the first guide section. The structure discussed above allows obtaining the reliable lens actuator in a simple construction.

### BRIEF DESCRIPTION OF THE DRAWINGS

FIG. 1 is a sectional view of a lens actuator in accordance with an embodiment of the present invention.

FIG. 2 is an exploded perspective view of the lens actuator in accordance with an embodiment of the present invention.

FIG. 3A is a perspective view of a component of the lens actuator in accordance with an embodiment of the present invention.

FIG. 3B is a perspective view of a component of the lens actuator in accordance with an embodiment of the present invention.

FIG. 4 is a sectional view of a conventional lens actuator.

FIG. 5 is an exploded perspective view of the conventional lens actuator.

### PREFERRED EMBODIMENT FOR CARRYING OUT THE INVENTION

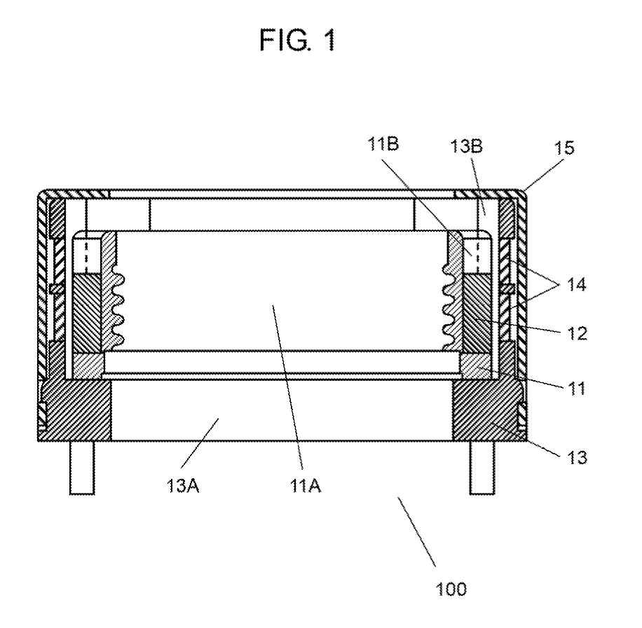

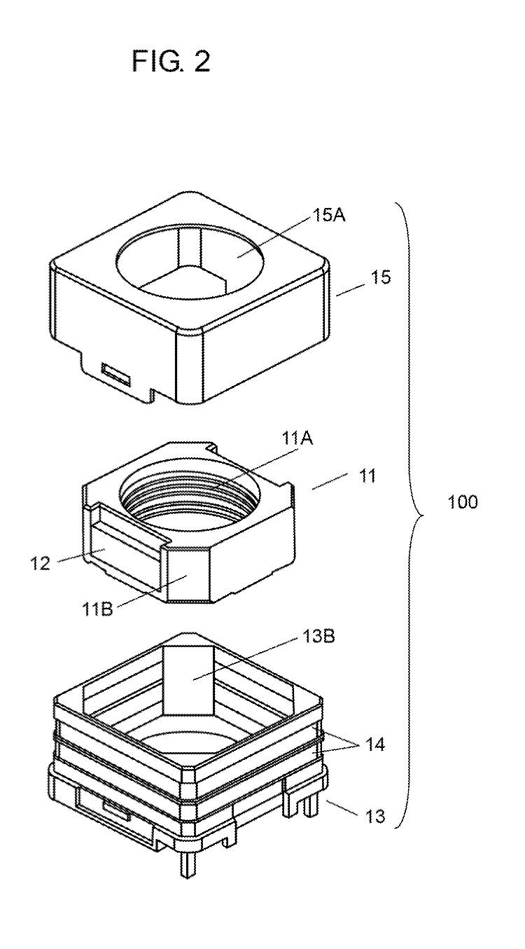

FIG. 1 is a sectional view of a lens actuator in accordance with the embodiment of the present invention. FIG. 2 is an exploded perspective view of the lens actuator in accordance with the embodiment of the present invention. Lens actuator 100 includes carrier 11, magnets 12, housing 13, coils 14, and cover 15. Carrier 11 is shaped like a prism and made of insulating resin, e.g. polycarbonate. Carrier 11 includes cylindrical hollow space 11A at the center. Magnet 12 is shaped like a plate and made of neodymium-based magnet. Each one of magnets 12 is disposed on the outer wall of carrier 11. In this embodiment, one magnet 12 is fixed to a first lateral face and another magnet 2 is fixed to a second lateral face opposite to the first lateral face, e.g. each magnet 2 is fixed to the left lateral face and right lateral face respectively.

Housing 13 is shaped like a box and made of insulating resin, e.g. polyphthalate-amide. Housing 13 has hole 13A on the bottom at the center. Coil 14 is made of copper alloy covered with insulating resin. Coils 14 are wound in a ringed-shape on the outer wall of housing 13 and separated into an upper coil and a lower coil. The upper coil is wound in a reverse direction to the lower coil.

Flat guide section 11B is formed vertically on each of four corners of the outer wall of carrier 11. Another flat guide section 13B is formed vertically on each of four corners of the inner wall of housing 13, and each flat guide section 13B confronts each flat guide section 11B, which can slide along guide section 13B. Carrier 11 can move up and down in housing 13 with the aid of guide sections 11B and 13B. Each magnet 12 confronts coils 14 with a given space therebetween.

Cover 15 is shaped like a box and made of Metal plate, e.g. steel sheet plated by nickel. Cover 15 includes round through-hole 15A at the center and covers the top face of housing 13. Lens actuator 100 is thus constructed.

The foregoing structure allows housing 13, of which outer wall is wounded by coils 14, to accommodate carrier 11, on which outer wall magnets 12 are rigidly mounted, and allows housing 13 to be covered with cover 15 at the top face. Assembly of this simple structure allows manufacturing lens actuator 100, so that the assembly can be done with ease within a short time.

A lens (not shown) is rigidly mounted in hollow space 11A of carrier 11, and an image sensor (not shown) is disposed behind lens actuator 100 (at the lower side in FIG. 1). Lens actuator 100 is then mounted in an electronic device, e.g. portable phone or electron camera, and coils 14 are connected to the electronic circuit of the electronic device via multiple electrodes or lead-wires (not shown).

Using the foregoing structure, a user presses a given button (not shown) of the device, and the electronic circuit applies a voltage to coil 14 so that an electric current runs through, e.g. lower coil 14 along a predetermined direction, and downward force perpendicular to and in response to the running direction of the electric current works on magnets 12. Magnets 12 and carrier 11, to which magnets 12 are mounted, are moved, e.g. downward in housing 13 with the aid of guide sections 11B and 13B. As a result, the focus of the lens mounted in hollow space 11A of carrier 11 is set at a standard mode which allows the camera to shoot an image whichever a distant one or a close one.

When the user presses another button (not shown), an electric current reversal to the foregoing one runs through upper coil 14, so that magnets 12 receive upward force, i.e. reversal to the foregoing downward force. Carrier 11 is thus moved upward in housing 13 with the aid of guide sections 11B and 13B. As a result, the focus of the lens mounted in hollow space 11A is set at a close-up mode which allow the camera to shoot an object as close as within a range from several cm (centimeter) to several tens cm.

To be more specific, when the electronic circuit of the device applies a voltage to coils 14, which are wound in opposite directions to each other, magnets 12 receive vertical force perpendicular to the electric current applied to coils 14. Carrier 11 to which magnets 12 are mounted moves vertically, i.e. along the first direction, in housing 13. As a result, the focus of the lens mounted in hollow space 11A can be set at the standard mode or the close-up mode.

At this time guide section 11B disposed at each corner on the outer wall of carrier 11 slides along each one of guide sections 13B disposed at each corner on the inner wall of housing 13, thereby moving carrier 11. Carrier 11 thus can move up and down in housing 13 free from slant or shake with the aid of guide sections 11B and 13B. This structure needs no shafts which have been used in the conventional lens actuator, and guide section 11B occupies only a small area at each corner of carrier 11, so that a larger magnet 12 than the conventional one can be mounted on the outer wall of carrier 11. As a result, greater magnetic force per magnet 12 can be expected, and thus carrier 11 can be moved more reliably and steadily. The use of greater magnets 12 allows reducing the total number of magnets 12, thereby reducing the number of components of the lens actuator.

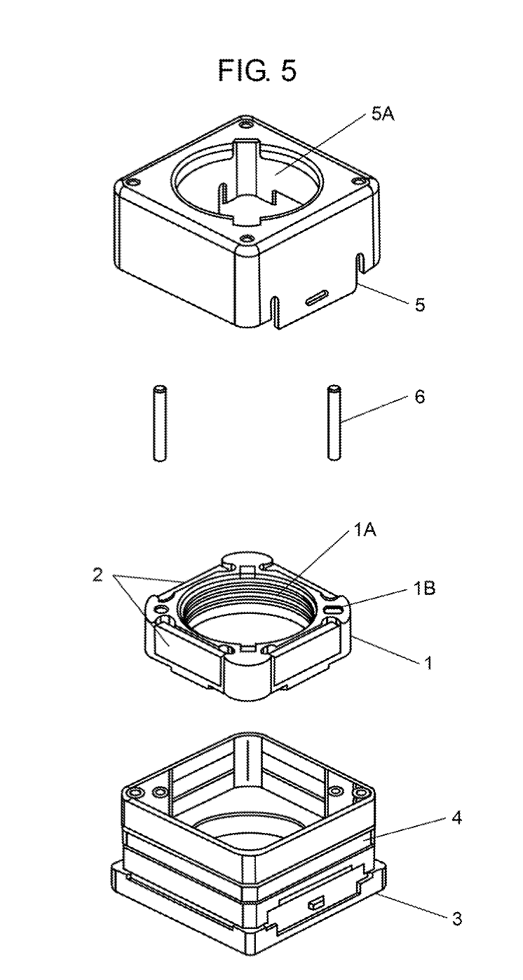

The foregoing structure saves housing 13 having a mechanism for guiding the shafts 6 necessary for the conventional lens actuator shown in FIG. 5. The elimination of this guiding mechanism allows housing 13 to have room in the vertical direction, so that the lens actuator per se can be downsized or the carrier can be greater in size. A degree of freedom in designing the lens actuator thus increases.

Magnets 12 are mounted on the outer wall of carrier 11 at the lateral faces confronting to each other. This structure allows carrier 11 to move up and down steadily free from slant, and allows reducing the number of magnets 12, so that the number of components in total can be reduced.

It is preferable to provide a clearance of approx. 5 μm between guide section 11B and guide section 13B. This clearance allows carrier 11 to move up and down in housing 13 more steadily and smoothly. Guide sections 11B and 13B are preferably formed as long as possible in the vertical direction so that carrier 11 can move up and down in housing 13 more smoothly and steadily. As shown in FIG. 2, it is preferable that each of guide sections 11B is formed from top to bottom on the outer wall of carrier 11. In this embodiment, prism-shaped carrier 11 and housing 13 are used; however, other polygonal shapes, e.g. hexagonal shape, can be used instead of prism-shaped ones. In such a case, it is preferable to form four or more than four guide sections 11B and four or more than four guide sections 13B at the corners of outer wall of carrier 11 and at the corners of inner wall of housing 13. This structure allows carrier 11 to move up and down in housing 13 more smoothly with greater reliability.

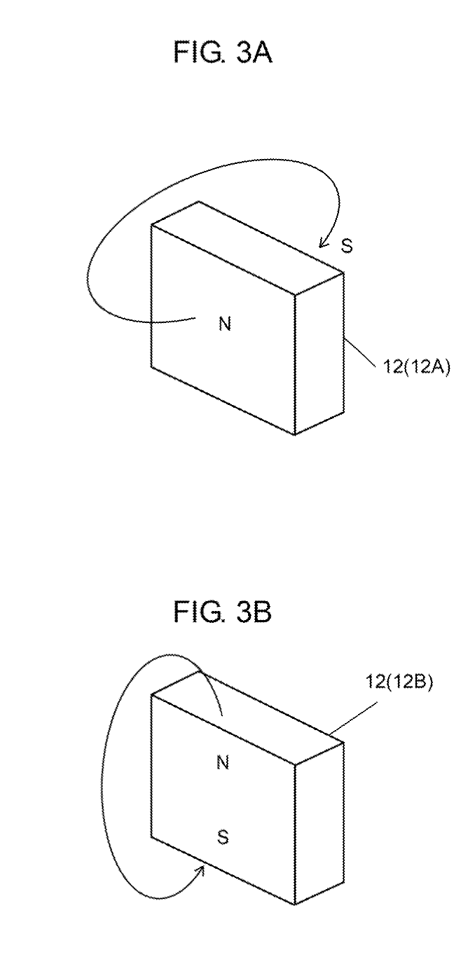

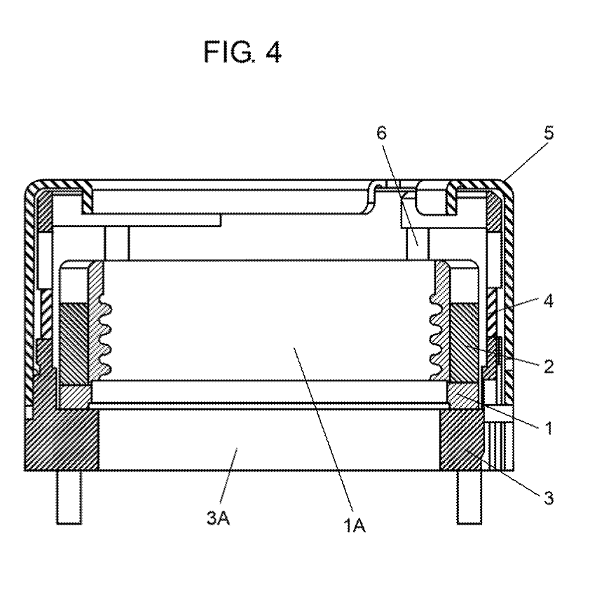

FIG. 3A and FIG. 3B are perspective views of magnet 12 of lens actuator 100. As shown in FIG. 3A, magnet 12A has N-pole and S-pole on front side and rear side respectively, namely, N-pole and S-pole are formed perpendicularly to the vertical direction along which carrier 11 moves. Use of this kind of magnet allows implementing the present invention; however, magnet 12B shown in FIG. 3B has N-pole and S-pole along the vertical direction, namely, N-pole and S-pole are formed in parallel to the vertical direction along which carrier 11 moves. Use of magnet 12B is more preferable because less leakage flux both to the outside and inside can be expected, and carrier 11 can move more efficiently.

Coil 14 is not necessarily separated into the upper one and the lower one, but single coil 14 can be wound on the outer wall of housing 13, and an electric current running in different directions from each other can be applied from the electronic circuit to this single coil 14 for moving carrier 11 up and down. However, as demonstrated in this embodiment, upper coil 14 and lower coil 14 are wound in a reverse direction to each other on the outer wall of housing 13, and an electric current is applied to one of the coils, thereby moving carrier 11 up and down. This structure saves the electronic circuit changing the direction of the current, so that the electronic circuit can be simpler and the control can be done with ease.

The foregoing description refers to the structure where coils 14 are wound on the outer wall of housing 13 and magnets 12 are disposed on the outer wall of carrier 11 such that magnets 12 confront coils 14; however, the present invention is not limited to this example. For instance, coils 14 can be wound on the outer wall of carrier 11, and magnets 12 are mounted on the inner wall of housing 13′.

In this embodiment, each of two magnets 12 is mounted on the lateral faces confronting to each other of carrier 11; however, each of four magnets 12 can be mounted on each of the four lateral faces with a similar advantage to what is discussed previously.

Lens actuator 100 in accordance with this embodiment includes guide sections 11B formed on the outer wall of carrier 11 and also includes guide sections 13B formed on the inner wall of housing 13. Guide section 11B confronts guide section 13B, so that carrier 11 can be held in housing 13 and can move up and down within housing 13. This structure allows eliminating the components, e.g. shafts, for guiding carrier 11, so that lens actuator 100 can be manufactured at a lower cost with a simpler structure. Lens actuator 100 thus manufactured works in reliable and steady manner. Larger magnet 12 can be mounted to carrier 11 or housing 13, so that greater magnetic force can be expected, which allows lens actuator 100 to work in more reliable and steady manner.

Since the lens actuator of the present invention can be manufactured in a simple structure and can work in reliable and steady manner, the lens actuator can be useful for moving the lens of portable phones and electron cameras.

What is claimed is:

1. A lens actuator comprising:
a box-shaped housing;
a prism-shaped carrier accommodated movably along a first direction in the housing and having a hollow space wherein a lens is mountable;
a magnet disposed at one of the carrier and the housing;
a coil disposed at one of the housing and the carrier such that the coil confronts the magnet,
wherein when the magnet is disposed at the carrier, the coil is disposed at the housing, and when the magnet is disposed at the housing, the coil is disposed at the carrier;
wherein the carrier includes a first flat guide section formed on a corner of outer wall thereof the carrier, and the housing includes a second flat guide section formed on a corner of inner wall thereof in a manner to confront slidably on the first flat guide section.

2. The lens actuator of claim 1, wherein the first guide section is formed on each of four corners of the outer wall of the carrier, and the second guide section is formed on each of four corners of the inner wall of the housing.

3. The lens actuator of claim 1, wherein the magnet is one of a plurality of magnets, and the magnets are disposed respectively on opposite surfaces of the outer wall of the carrier.

4. The lens actuator of claim 1, wherein the coil includes two separate coils wound in opposite directions to each other.
